(19) United States
(12) Patent Application Publication
(10) Pub. No.: US 2004/0156387 A1
(43) Pub. Date: Aug. 12, 2004

(54) Dynamic common data channel time-slot allocation to receivers of a data communication system based on a rate factor and the current acceptable transmission rate reported by or predicted for each receiver

(76) Inventor: Aharon Shapira, Haifa (IL)

Correspondence Address: Nath & Associates, Sixth Floor, 1030 15th Street NW, Washington, DC, 20005, US

(21) Appl. No.: 10/476,159

(22) PCT Filed: Apr. 25, 2002
(86) PCT No.: PCT/IL02/00328

(30) Foreign Application Priority Data
Apr. 29, 2001 (IT) 142843

(51) Int. Cl. H04Q 7/00; H04Q 7/28; H04B 7/212; H04J 3/16

(52) U.S. Cl. 370/443; 370/437; 370/329; 370/341; 370/348

(57) ABSTRACT

An adaptive slot allocation system (50) is connectable to a data transmission system that transmits data from a transmitter (10) to a plurality of receivers over a common channel in successive time slots, each time slot being allocatable to one particular receiver for transmitting data thereto, there being for each receiver during each time slot, a given acceptable transmission rate (ATR), derived from a corresponding measured signal-to-noise ratio (SNR) reported by the receiver. All subscriber units the transmission queue currently holds data to it will be referred as belonging to a queue group. The adaptive slot allocation system (50) includes a queue group identifier (53), operative to identify all receivers belonging to the queue group and a rate factors calculator (54), operative to determine for each receiver of the queue group a rate factor. A slots allocator (51) is receptive to outputs of the queue group identifier and the rate factors calculator and is operative to allocate any time slot to any receiver of the queue group, based on ATRs and rate factors of a plurality of receivers in the queue group. A transmission scores accumulator (52) is operative to cumulatively add amounts of data sent to any receiver. In a thirs algorithm, the receiver with the highest priority score being a wieghted factor of a deficit factor and the current ATR is assigned the actual slot.

### FIELD OF THE INVENTION

This invention relates to digital data communication over a multiple-access radio communication system and, in particular, to dynamic allocation of downlink transmission resources among subscribers linked to a transmitter, such as mobile units linked to a base station in a cellular data communication system.

### BACKGROUND OF THE INVENTION

It is projected that within the next few years, cellular telephone communication systems will convey more digital data than voice traffic. This is going to impact on the manner in which cellular service providers finance their services. As is known, when voice is conveyed over telephone systems there must exist a channel dedicated to the purpose between the calling and called parties; the cost to the calling party is based on the length of time that this dedication is maintained, regardless of the amount of voice traffic that is actually transmitted, since the users keep utilizing network resources as long as they hold the line. This is not the case for communication of digital data, where the data is split into data packets that are sent separately. At the receiving end, the received data packets may be received disjointly and are re-assembled in sequence according to sequence information transmitted therealong and are then forwarded to the called party. The cost to the calling party is based on the number of data packets that are sent; the larger the number of data packets, the higher the cost to the subscriber, generally regardless of the time it took to transmit them. This is due to the fact that the user occupies network resources only as long as he has packets to send; at idle periods, the resources may be switched to route packets of another user. It is therefore of great economic interest to the service provider to maximize the data throughput, since the more data he can transmit per unit of time, the more income he can generate. It is generally also in the interest of the subscriber that the total time it takes to transmit the data be as small as possible. To this end, a service provider may offer several classes of service, each associated with a priority value, which, in the case of non-streaming applications (i.e. not related to real time information, such as voice and video), guarantees a corresponding relative average data transmission rate, (also referred to as average bit-rate or bandwidth). The fee per data packet would then be set differentially among the classes.

A typical cellular communications system comprises a network of base stations, each base station being linked, at any time, with a plurality of subscriber units, which are generally mobile. In the context of data communication, “linked” means that the base station and the linked subscriber unit are tuned to each other, i.e. are receptive to mutual control signals, aware of the transmission parameters and ready to transmit or receive data between each other. All switched on subscriber units within a cell are normally linked to the respective base station, i.e. are in respective linkages. It is expected that, in general, the overwhelming proportion of data traffic will be from base stations to subscriber units, i.e. over downlinks; the present invention is particularly applicable to such downlink traffic. In cellular communications systems, all calls in each cell are managed by a respective base station and as a subscriber unit moves from one cell to another, the current base station hands the call to the base station in an adjacent cell in a process known as “handoff” (or sometimes “handover”); in such a case the linkages change. The methods of the present invention are applicable to any base station with respect to linkages existing at any particular time period.

Each base station is capable of transmitting radio signals over a given band of frequencies. In a conventional cellular communications system, namely one designed for voice transmission, these signals are structured, by any of a variety of multiplexing methods, to provide the required dedicated channels to the several active subscriber units. Moreover, there must also be differentiation between the signals transmitted by mutually adjacent base stations in order to avoid mutual interference; this is usually accomplished by different frequency bands, but may also be accomplished by other differentiation methods, such as code division. In a cellular data communications system, on the other hand, data packets may, at various times, be sent to any linked subscriber unit, the number of packets and their frequency being variable. Under such circumstances there is no purpose in maintaining separate channels, in the conventional sense. Rather, all linkages within a cell are normally through a single common channel, which utilizes the total bandwidth available to the base station. In any case, the present invention is applicable to any one channel, which a plurality of subscriber units may share. As in conventional cellular systems, though, the signals from adjacent base stations in a cellular data system must be differentiated, e.g. by frequency bands or codes, to avoid interference. Since there is, in general, a finite number of such mutually exclusive frequency bands or codes available, there will always be a potential for a certain amount of interference from nearby (albeit not adjacent) base stations, which are referred to as co-channel stations.

The manner in which data packets are transmitted from a base station to the various subscriber units while sharing the common channel, usually by dividing among themselves the times of its use, is subject to suitable protocols. One such protocol is part of a recently published standard for cellular data communication, named 1xEV-DO and called HDR (for High Data Rate). According to this standard, time is divided into a consecutive series of slots, each of 1.67 millisecond duration, all the data within a slot being addressed to any one particular subscriber unit. The slot is then said to be allocated to that subscriber unit. The present invention will be described in terms of this slot structure, but should be understood to be applicable, with obvious modifications, also to other protocols. in fact, data distribution in cellular data communications systems, rather than being based on a time division protocol, as in HDR, could also be based on other modes of division of the transmission resources, such as division by frequency or by code, whereby units of that division (which are akin to channels in a conventional system) are continuously and variably allocated to various subscriber units to carry data thereto. The present invention could be applied, with obvious modifications, to such systems as well.

In terms of a typical cell within a cellular data communication system, operating according to HDR standards, the situation addressed by the present invention is that data packets are continuously or sporadically received by the base station from the network, each packet addressed to a particular subscriber unit. The packets are stored in a buffer memory at the base station, as respective downlink transmission queues, then retrieved in a FIFO sequence and transmitted over the downlink channel to their respective subscriber units within respectively allocated time slots.

The maximal rate at which data packets can be reliably transmitted in a cellular communications system to any one subscriber unit depends on the subscriber unit's reception conditions, primarily—the signal-to-noise ratio (SNR) and the signal-to-interference ratio (SIR). Both depend, in turn, on the strength (i.e. power level) of the received signal. The noise originates from various sources and may vary with time and location. Interference originates from co-channel base stations and may vary with their transmission activity. In the context of the present disclosure, both effects will be treated in combination and will be referred to in common as signal-to-noise ratio (SNR). By their nature, subscriber units in cellular telephone systems are mobile and the received signal strength is therefore constantly changing. When a receiver is close to the base station, the average signal strength is high, while for a receiver that is remote from the base station the average signal strength is low. Thus also the average SNR in any subscriber unit varies generally with its position within the cell and is usually high when near the base station and low—when far from the base station. In addition, the received signal strength may also vary according to a highly position sensitive function, due to mutipath interference effects (also known as Rayleigh fading ). The fading function has statistical characteristics and can be described as band limited Gaussian noise. The fading bandwidth is proportional to the speed of the mobile unit and to the carrier frequency and its amplitude may vary significantly. Commensurately, also the SNR of any subscriber unit may, in addition to being, on the average, a function of position in the cell, as mentioned above, also rapidly vary with position according to the Rayleigh fading function.

For any given SNR at the subscriber unit, there is a rate at which data may be transmitted to it with a given level of error rate. Thus, for a chosen level of error rate, a suitable data transmission rate may be specified for any prevailing SNR. The base station thus needs to know the SNR of the subscriber unit to which it is about to send data, in order to send it at the just appropriate rate; a higher rate would result in errors, while a lower rate would be wasteful of the resources and would result in the average throughput being lower—which is against the interests of all parties. Since, as explained above, the SNR at each subscriber unit is likely to change, its value should be frequently conveyed to the base station. According to HDR standards, the SNR at each linked subscriber unit is measured at each slot time and the result conveyed to the base station. Consequently, the base station determines (with the aid of stored look-up tables) at the beginning of each slot time the rate at which data will be transmitted during that slot, according to the SNR last conveyed from the subscriber unit to which the slot is allocated. This procedure is based on the generally realistic assumption that the SNR remains fairly constant over the duration of two consecutive slots.

While the protocol and practice described last assure that at any slot and for any subscriber unit to which the slot is currently allocated, the transmission rate is optimal, there is nothing prescribed in them as to how each slot should be allocated among the subscriber units. Several considerations should, in general, guide such allocation, some of which are as follows:

a. A slot should be allotted to any subscriber unit only to the extent that its transmission queue currently holds any data addressed to it. All such subscriber units as a group will be referred to as belonging at any time to a queue group.

b. The overall transmitted data throughput (as summed over some given period of time) should be as high as possible.

c. Every active subscriber unit should receive the data addressed to it with minimal delay.

d. Slots should be allocated to the subscriber unit of the queue group so that each receives a fair share of the transmitted data, regardless of its SNR (and therefore also regardless of its position in the cell). The term “fair share” here means that, if subscriber units are distinguishable by priority classes, the share of each subscriber unit is proportional to its priority; otherwise all shares are equal.

Consideration ‘a’ is obvious, if slots are not to be wasted. Consideration ‘b’ is in the interest of the system operator, as discussed further above. Considerations ‘c’ and ‘d’, which are interrelated, are in the interests of the subscribers and also of the system operator, as an equitable service provider. Even with these latter considerations alone, it is a non-trivial task to devise a suitable scheme for slot allocation, this being one object of the present invention. As will be discussed below, there is some inherent conflict between ‘b’, on the one hand, and ‘c’ and ‘d’, on the other hand. It is a further non-trivial task to resolve this conflict in some optimal manner, and this is another object of the present invention. To illustrate the problem, two examples of extremely simple schemes will now be presented.

In the first example only considerations ‘a’ and ‘b’ are, in effect, brought to bear, as follows: At each slot time the SNRs of all active subscriber units are compared and the slot is allocated to the one with the highest SNR. Clearly, with this scheme, the transmission rate at any time is the highest possible and thus the throughput is maximized. However, nearby subscriber units are thus likely to be the ones receiving most, if not all, of the data over any period of time, causing distant subscriber units to receive much less than their fair share over that period and to wait a long time to receive all their data—namely only after the queues of the nearby subscriber units have been exhausted.

In the second example, only considerations ‘a’ and ‘d’ are brought to bear, though not very effectively, as follows: Slots are simply allocated to all active subscriber units sequentially in a Round-Robin manner. Class priorities may be brought into effect by allocating to each subscriber unit a commensurate number of slots in each cycle. Now each active subscriber unit will get a fair share of the slots over any period of time, but not necessarily of the transmitted data, because subscriber units with low SNR will get commensurately less data than those with high SNR. Moreover, the overall throughput will be much less than the maximum, because for any subscriber unit the SNR at each allocated slot may have any value over its range of variation and thus the average transmission rate will be less than the maximum possible for that subscriber unit.

The scheme of the third example is a modification of that of the second example, whereby consideration ‘d’ is more closely adhered to, namely: At its turn in the cycle, each subscriber unit is allotted a number of consecutive slots in inverse proportion to its currently indicated transmission rate (or current SNR). Now the transmitted data will be more evenly divided among the active subscriber units, but the overall throughput will remain considerably under the maximum possible, because of the still random time relation between the slots allotted to any one subscriber unit and the occurrence of maximum SNR condition at that subscriber unit.

There is thus a need for a method to allocate time slots of a downlink data transmission channel, whereby data stored in the transmission queues of the base station will be transmitted to the respective subscriber units at rates that, when averaged over a given period of time, are reasonably proportional to the respective priority classes and whereby the overall amount of data transmitted over that period is reasonably close to the maximum amount possible under the then effective transmission conditions.

### SUMMARY OF THE INVENTION

The invention provides a method for dynamically allocating resources of data transmission from a transmitter to linked receivers in a multiaccess digital data communication system that is typified by differential and variable optimal transmission rates to the various receivers, due to their differential and variable signal-to-noise ratios (SNRs). A common and representative example of such a system is a wireless data broadcasting system, such as a single cell in a cellular data communication system, with reference to downlink transmission from the central station to the receiver portions of linked receivers in the cell. The disclosure herein is in terms of such a wireless system, but the invention should be understood to be applicable to other communication systems with variable reception characteristics. Typically, as explained in the Background section above, data transmission in such systems is carried out over a single channel, to which the receivers of all linked receivers are receptive, but which carries, at any particular time, data for only one receiver. Thus, the resource to be allocated among the linked receivers is time. In the present disclosure, the invention is described as applicable to data transmission system based on the HDR standards, but it will be readily understood to apply, with obvious modifications, to other systems as well. According to the HDR standards, time is divided into slots, of 1.67 millisecond duration each, during which data is transmitted to any one receiver. These time slots are the allocatable resource units and it is schemes for their continuous allocation among linked receivers that the invention provides in this case. The method of the invention is particularly applicable when the data being transmitted by the system is not a streaming data, i.e. it has no affinity to real time, as would, for example, have any data that carry voice- or video information. Data to be transmitted to receivers of various subscriber units are received by the transmitter station, usually over the inter-cell network, and stored in a buffer storage therein as corresponding queues. At any instant of time there may typically be queues of transmittable data for some of the linked receivers. The group containing all such receivers will be called a queue group. A queue group is changeable with time, as queues are formed by new data received by the transmitter station or exhausted by downlink transmission to respective receivers.

Further according to the HDR standards, the SNR of each receiver is continuously monitored and each obtained SNR value is converted, according to some formula or table, into a corresponding acceptable data rate (ATR), which is the highest rate at which data may be transmitted to the receiver with the likely level of errors being under some acceptable threshold. The SNR-, or the corresponding ATR-, values are immediately communicated to the transmitter at least once for each slot. It is common practice, also followed in the context of the present invention, to send data to any receiver at a rate equal to the corresponding ATR as last reported.

The method of resource allocation according to the invention is guided by two functional principles and aims at fulfilling them simultaneously to the greatest extent possible. The method is illustrated in the detailed description below, in terms of three specific algorithms, which realize it with varying emphasis among the two principles, but should be understood in a broader sense, as disclosed herein. The two principles are:

(A) Over some given period of time, the amount of data transmitted to each receiver of the queue group, relative to all others, should be as nearly proportional to its priority level as possible; if there are no priorities in the system, the proportionality becomes equality meaning that equal priorities are defined for all subscriber units.

(B) The total amount of data transmitted over some given period of time (i.e. the total throughput) should be as large as possible, in keeping with principle ‘A’.

To fulfill these functional principles, the method makes use of the following operational principles (all stated in terms of time-slots as transmission resource):

(a) For each receiver an average of its ATR values over some given period of time is continuously or periodically computed;

(b) The assignment of each slot is based on the current (i.e. last reported) ATRs of all receivers of the queue group.

(c) Periodically there is a planning phase, in which a desired relative number of slots to be assigned to each receiver of the queue group is temporarily determined; the determination is based on the priorities of the respective receivers and on their average ATRs.

(d) Periodically there is a planning phase, in which a desired relative quantity of data to be allocated, or a desired cumulative data rate, is determined, based on the priorities of the respective receivers.

(e) Running scores are kept of the cumulative quantity of data transmitted to each receiver.

Not all these operational principles are used in every embodiment (algorithm) of the method, but most of them always are.

The method as a whole is characterized by dynamic adaptivity, in that it specifies frequently recurrent examination of the transmission parameters—data in the transmission queues, subscriber priorities and ATRs—and making slot allotment and assignments based on the results. The reliance on the ATR at each slot time in deciding on its assignment is an important feature of the invention, in that it enables following the fast variations in SNR and choosing instants at which it is relatively high, to thus increase the overall transmission rate. Three algorithms are disclosed, and fully described in the next section, as representative embodiments of the method. They will now be briefly explained, with reference to the above operational principles, to thereby convey the essence of the invented method. The first two algorithms aim at primarily fulfilling functional principle A and secondarily—functional principle B; that is, these two algorithms are designed to cause the quantity of data transmitted to each receiver of the queue group over some finite time period to be strictly in proportion to their respective priorities (or, absent any priority classification, to be mutually equal). The third algorithm provides a flexible, adjustable, weighting of the effects of the two principles; that is, the user can prescribe the relative importance of the two functional principles in the scheme that determines specific slot allocations. In the first two algorithms a particular variable, termed “gain factor”, is continuously computed for each receiver and used in the allocation process; it is the ratio of current ATR to an average of ATRs over a time period. Gain factor is thus a measure of the instantaneous reception capability of a receiver relative to its own average and its uses increase the likelihood that, if some amount of data has to be sent to any receiver, this will occur at the optimal slots, thus maximizing the overall transmission rate.

The first algorithm incorporates principles (a), (b), (d), and (e), as follows: At each planning phase, a predetermined quantity of data is considered. This quantity is divided among all receivers of the queue group in proportion to their priorities. At each slot time, an average ATR is computed for each receiver of the queue group over a just preceding period of a predetermined duration and therefrom a gain factor is computed as the ratio of actual ATR (i.e. that reported for the just preceding slot) to the average ATR. The gain factors of all receivers of the queue group are compared and the one with the highest gain factor is assigned the slot. A receiver that has received its allotted quantity ceases to be considered in the comparison until next planning phase. The process repeats until all planned quantity has been transmitted. The use of gain factor in this algorithm is an important feature.

The second algorithm incorporates principles (a), (c), (d) and (e). It includes a planning phase in which a planning frame of a predetermined number of slots is considered. Here it is assumed that there are prediction values available for the ATRs of all receivers of the queue group at all slots of the planning frame. An amount of data is determined and divided among the receivers of the queue group, to become their respective allotments, in proportion to their priorities, the allotments being the data quantities transmittable to the respective receivers during the planning frame according to the averages of the respective predicted ATR values. Assignment of slots over the entire planning frame is determined at its beginning (rather than at each slot time, as in the first algorithm). The determination is based on comparison, for each slot, of gain factor values that are computed for each receiver as the ratio of the respective predicted ATR to the respective average of the predicted ATRs. A situation often arises of the entire allotted amount being (predictably) transmittable over only part of the slots of the planning frame, in which case, further allotments are similarly made and the remaining slots are allocated accordingly. After the passage of the planning frame, the amounts of data actually transmitted to all receivers of the queue group are compared to each other, and to the extent that their proportions differ from the ratios of the respective priorities, the allotments of the various receivers at the next planning phase are adjusted in proportion to the respective differences. The use of predicted values in assigning slots over a planning frame is a feature of the invention, having the additional advantage that it allows choosing, for many receivers, the slots in which they are likely to have the highest gain factors, thus further maximizing overall transmission rate.

The third algorithm incorporates principles (b), (d) and (e) and differs from the other two regarding the planning phase in that it is not associated with fixed amounts of data or fixed time frames, but rather occurs each time that any receiver joins or leaves the queue group. At these planning instances, desired relative data transmission rates are determined for all receivers of the queue group. For each receiver of the queue group, cumulative scores are kept of the time-integrated desired transmission rate and of the quantity of data actually transmitted; also, a ratio between the two scores is continuously computed, to become a “deficit factor”. At each slot time, a “priority score” is computed for each receiver of the queue group, which is a weighted function of its deficit factor and its current ATR. The receiver with the highest priority score is assigned the current slot. It is noted that this process forms a feedback control loop, in which the slot allocation scheme acts to gradually reduce any deficit factor (or its inverse, in the case of overage) to unity. The rate at which this reduction occurs, and the remaining shortage, is determined by the relative weights in the computation of the preference factor. On the other hand, the relative weights determine in an opposite sense the effect of the current ATR on slot allocation and hence they determine the overall throughput. The algorithm thus provides an adjustable balance between equitable slot allocation and overall transmission efficiency.

Clearly, other algorithms are possible according to the invention, all based on various combinations of at least three of the operational principles stated above.

It will also be understood that the invention contemplates a computer program being readable by a computer for executing the method of the invention. The invention further contemplates a machine-readable memory tangibly embodying a program of instructions executable by the machine for executing the method of the invention. The invention further contemplates a system, embodied as hardware—or software components, operative to carry out the method of the invention.

Specifically, the invention provides in a data transmission system for transmitting data from a transmitter to a plurality of receivers over a common channel in successive time slots, each time slot being allocatable to one particular receiver for transmitting data thereto, there being, for each receiver during each time slot, a given acceptable transmission rate (ATR), derived from a corresponding measured signal-to-noise ratio (SNR),there optionally being a priority value associated with each receiver and there being at any instant a quantity of data queued at the transmitter for transmission to each of a group of receivers, this group being termed a queue group, a method for adaptively allocating time slots to receivers, comprising the steps of:

(i) identifying all receivers belonging to the queue group;

(ii) determining for each receiver of the queue group a rate factor;

(iii) allocating any time slot to any receiver of the queue group, based on ATRs, and said rate factors, if any, of a plurality of receivers in the queue group;

(iv) cumulatively adding amounts of data sent to any receiver, to obtain a respective cumulative transmission score.

According to a further feature of the invention, allocation of any time slot is based on the ATRs of a plurality of receivers in the queue group for that time slot.

According to another further feature of the invention, the method further includes the step of calculating, for any receiver and for any slot, an average ATR over a given number of preceding slots and calculating, for any receiver and for any time slot, the ratio of the respective ATR to the corresponding average ATR, to obtain a respective gain factor, and allocation of any time slot is based on the gain factors of a plurality of receivers for that slot.

According to yet another feature of the invention, if in the system there is a priority value associated with each receiver, each rate factor is directly related to the ratio between the priority of the respective receiver and the priorities of all other receivers of the queue group, else all rate factors are equal.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a flowchart illustrating a first preferred algorithm according to the method of the invention;

FIGS. 2A and 2B are a flowchart illustrating a second preferred algorithm according to the method of the invention;

FIG. 3 is a flowchart illustrating a third preferred algorithm according to the method of the invention;

FIG. 4 is a schematic control path diagram illustrating the operational principle of the preferred algorithm of FIG. 3; and

FIG. 5 is a block diagram of a preferred embodiment of a slot allocation system according to the invention.

### DETAILED DESCRIPTION OF THE INVENTION

The three algorithms representing the preferred embodiments of the invention will now be described in detail. The description is, by way of example, in terms of data transmission from a base station to subscriber units linked thereto within a cellular data communication system operating according to HDR standards. It is however applicable, with obvious minor modifications, to other cellular systems and, with further obvious modifications—to other multi-access data transmission systems, where data is transmitted from a transmitter to a plurality of receivers over a single channel, with some definable method of resource allocation and with information about acceptable transmission rate to each receiver being continuously available to the transmitter.

Generally, the method calls for two alternating phases of operation—(a) an allotting phase, in which there is determined an amount of data to be transmitted to each subscriber unit until the next allotting phase, or, alternatively, a desired average rate of data transmission to each subscriber unit, and (b) an allocation phase, in which any one slot is assigned to a particular subscriber unit. All calculations take place at the base station and are based on the data stored at the transmission queues, on the respective priorities of the subscriber units and on SNR- or ATR information received from each linked subscriber unit at each slot time. SNR- or ATR values for a just preceding slot are termed current SNR or -ATR. The priority of each subscriber unit, which is associated with its class of service, is assumed to be available; if there are no priorities in the system, all priority are set to an equal value, say 1.

Steps common to all the algorithms, carried out periodically, are:

1. A group of subscriber units is identified as those of the currently linked subscriber units for which data is stored in the respective transmission queues; this group is termed the queue group.

2. The priorities of all N subscriber units in the queue group are noted.

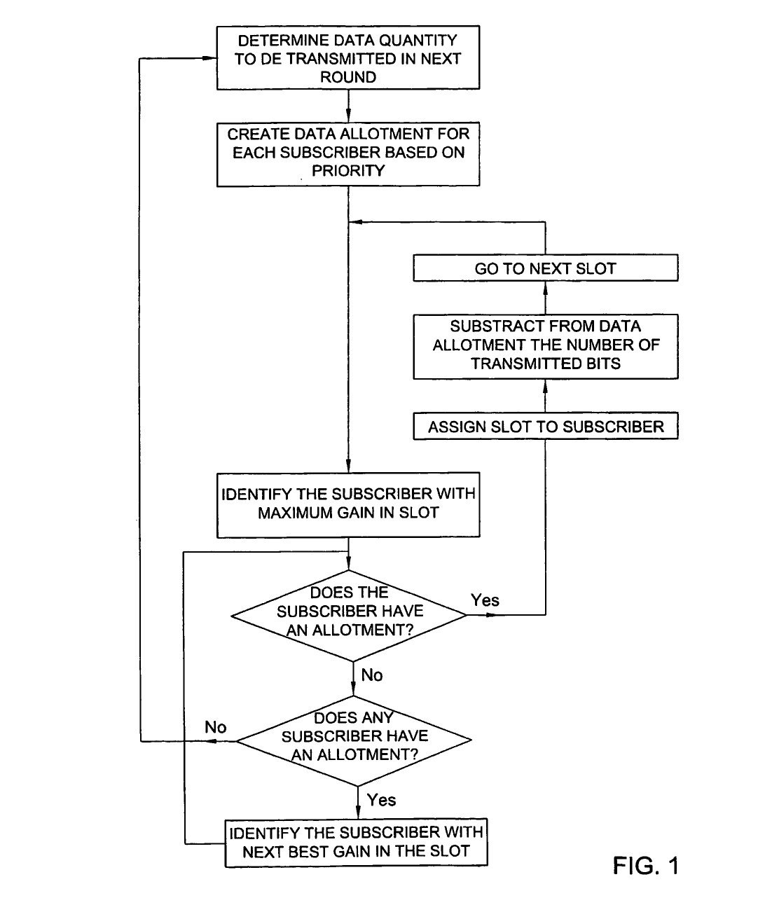

The first algorithm is illustrated by the flow diagram of FIG. 1. From time to time, an overall quantity of data is considered for transmission. This quantity is divided among the N units of the queue group in proportion to their priorities, to become their respective allotments. At each slot time, the subscriber unit with the highest gain is selected and its allotment is reduced by the amount of data transmitted to it; if the allotment has already been reduced to zero, another unit is selected. When all allotments reach zero, another allotting phase is undertaken.

During an allotting phase the following is done:

1. An amount of data to be transmitted over the next round is determined.

2. The transmittable amount is divided into N portions, in proportion to the respective priorities of the subscriber units in the queue group, each portion to be referred to as the respective allotment.

3. Each allotment that exceeds the amount of data stored in the corresponding queue is preferably reduced to equal the respective stored amount; the transmittable quantity in excess of these reduced allotments is then preferably redivided among all other subscriber units, again in proportion to their respective priorities, to become their respective allotments, and this process is preferably repeated until the amount of stored data in the queue of any subscriber unit equals or exceeds the corresponding allotment.

During an allocation phase, which occurs prior to each consecutive slot time, the following is done with respect to the subscriber units of the current queue group:

4. The current ATR of each subscriber unit is obtained—either directly or on the basis of the respective reported SNR value.

5. An average ATR is computed for each subscriber unit over a just preceding period, of a predetermined duration (for example—of 100 slots).

6. A gain is computed for each subscriber unit as the ratio of the current ATR to the average ATR.

7. The gains of all subscriber units that have non-zero allotments are compared to each other and the one with the highest gain is selected and assigned the slot.

8. A quantity of data, commensurate with the duration of a slot and with the current ATR of the selected subscriber unit is retrieved from the respective transmission queue and transmitted to that subscriber unit.

9. The amount of data transmitted to the selected subscriber unit is subtracted from its allotment.

Additional slots are allocated in the same manner, until all allotments have been reduced to zero, at which time another allotting phase takes place to allot, and subsequently allocate and transmit, another quantity of data.

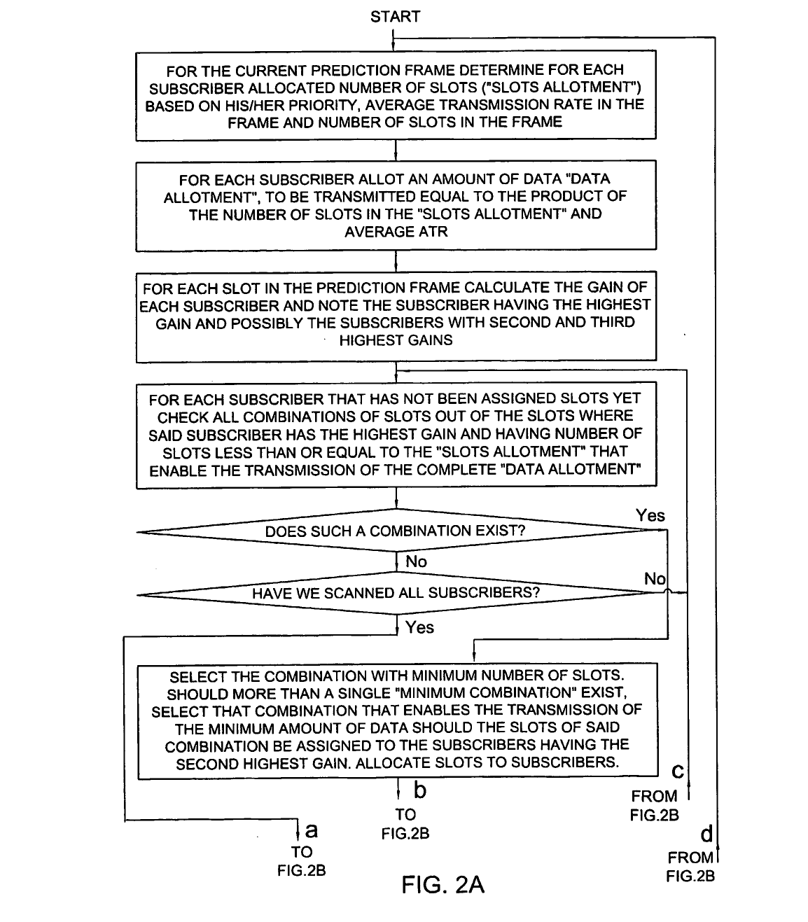

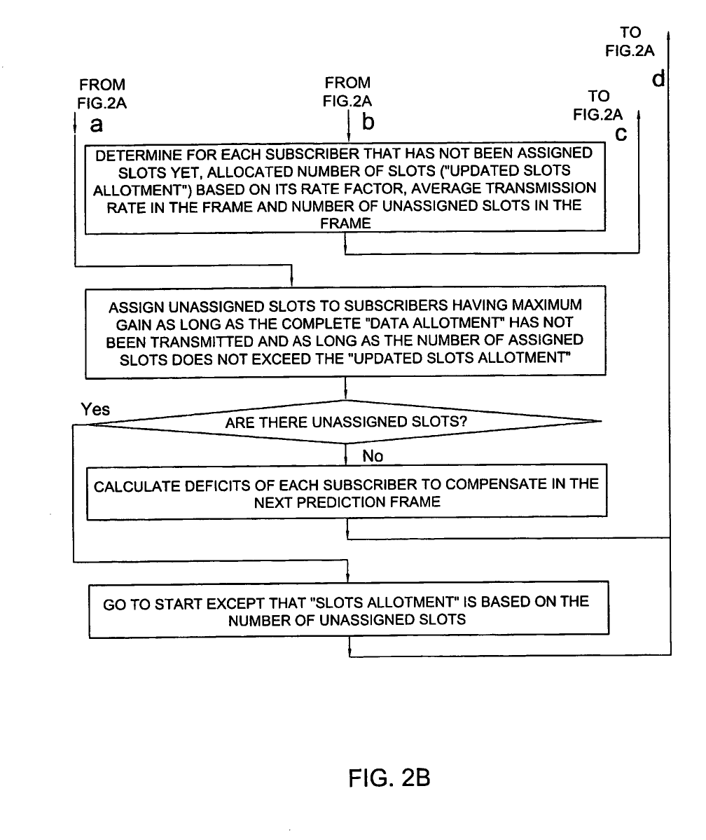

The second algorithm is illustrated by the flow diagram of FIGS. 2A and 2B. It is based on periodic prediction frames of a predetermined number F of consecutive slots each, whereby predicted values for the ATR of each subscriber unit of the queue group at each of the F slots are available. Both allotting and allocating are performed at the beginning of each frame, whereby there may, in general, be several allotting phases, interleaved with allocation phases.

At the initial allotting phase the following steps are taken:

1. A queue group is identified and the priorities of its N subscriber units are noted.

2. The average ATR of each subscriber unit of the queue group is computed, preferably—from all the respective predicted values in the frame.

3. The number of slots, F, is divided among the N subscriber units, to become their respective slots allotments S, so that each slots allotment, S, is proportional to the respective priority divided by the respective average ATR.

4. Each slots allotment is multiplied by the respective average ATR, to become a respective data allotment; if the data allotment of any subscriber unit exceeds the amount of data in the respective queue, its slots allotment is preferably reduced correspondingly and the total of such slot reductions is added proportionally to the other subscriber units of the queue group, whereupon this entire step is repeated.

At the first allocation phase the following steps are taken:

5. A predicted gain is computed for each subscriber unit of the queue group at each slot, as the ratio of the respective predicted ATR to the average ATR of the subscriber unit.

6. For each slot, the predicted gains of all subscriber units of the queue group are compared and the subscriber units with the highest gains, and preferably also those with the second-highest gains, are noted.

7. A subscriber unit, whose entire data allotment can be transmitted within any S slots at which it has the highest gain (which are not necessarily consecutive), is identified and assigned a certain group of these slots (including possibly all of them), namely the smallest group over which the entire data allotment can be transmitted at the respective predicted ATRs; if there is more than one such group of slots, the assigned group of slots will preferably be that over which the minimal amount of data can be transmitted at the respective predicted ATRs to subscriber units that have, respectively, second-highest gains in them. This procedure is repeated for other units until there is no subscriber unit left that has a maximum predicted gain at any unassigned slot and can predictably have its entire data allotment transmitted over a number S of such slots.

If, after step 7, there remain from the considered slots any that have not been assigned and if there remain any subscriber units for which no slots have been assigned, a series of additional allotment and allocation phases is undertaken, as follows:

8. The number F′ of remaining slots is divided among the N′ remaining subscriber units, to become their respective slots allotments, so that each slots allotment is proportional to the respective priority divided by the respective average ATR.

9. Steps 6 and 7 are carried out with respect to all F′ remaining slots and with respect to the remaining N′ subscriber units.

10. Steps 8 and 9 are repeated as long as there remain unassigned slots and subscriber units without allocated slots and as long as there is at least one group of slots assignable as specified in step 7.

If, after step 10, there remain from the considered slots any that have not been assigned and if there remain any subscriber units for whom no slots have been assigned, a series of additional allotment and allocation phases is undertaken, as follows:

11. The number F″ of remaining slots is divided among the N″ remaining subscriber units, to become their respective slots allotments, so that each slots allotment is proportional to the respective priority divided by the respective average ATR.

12. Considered for allocation is any of the N″ remaining subscriber units that has not yet been allocated its entire slots allotment and that the entire data predictably transmittable over the slots assigned to it so far does not exceed its entire data allotment.

13. Each of the F″ slots, in turn, is assigned to the subscriber unit, from among those considered according to step 12, that has the highest gain factor in it.

14. Steps 11-13 are repeated as long as there remain any unassigned slots and as long as there remain any subscriber units that have been allocated their entire respective slots allotment while the entire amount of data predictably transmittable over their respective assigned slots is less than their respective data allotments.

If, after step 14, all the data allotments of all subscriber units are predictably transmittable over their respective assigned slots, but there remain any unassigned slots within the frame, steps 3-14 are repeated with respect to all the remaining slots (whose number is, say, F′″), whereby, for example, in step 3, the remaining number of slots F′″ is divided among all N subscriber units. It is noted that such a repetition results in additional data allotments, beyond the initial ones, and is likely to occur in most cases, since the initial allotting of data is based on average ATRs, whereas the expected data transmissions over the eventually allocated slots, as specified above, are based on high gain factors (presumably much greater than 1), thus utilizing less slots than there are in the entire frame. To the extent that actual ATRs will be close to the predicted values, these additional allotments represent the throughput gain effected by the use of comparative gain factors for slot allocation, which is a feature of the invention.

It is also noted that step 7 above includes a further feature of the invention, inherent to this prediction-based algorithm, in that it utilizes the predicted values to more efficiently allocate time slots than can be done when allocating one slot at a time, by considering for each subscriber unit several slots at once and selecting those with the highest gains, thus maximizing the expected throughput.

It is further noted that, as a result of the above procedure, all slots of the prediction frame become a priori allocated to the various subscriber units of the queue group so that, if the data were transmitted to each receiver over all of its assigned slots at the respective predicted ATRs, the ratios between the amounts of data thus transmitted to the various subscriber units would be essentially proportional to their respective rate factors. These ratios will deviate from exact proportionality only to the extent that, after the last iteration of step 14 (when all slots of the frame will have been assigned), there remain any subscriber units whose predictably transmittable data is less than their respective data allotments. Such predicted shortages are, however, likely to be relatively small and, in any case, what will finally count are the actual amounts of data that will be transmitted over the frame, as will now be discussed.

If and when all slots of the prediction frame have been allocated, actual transmission can commence. At each slot, data is transmitted to the subscriber unit to which the slot was assigned (to the extent that it still has any data in the queue); however, the transmission rate is at the actual current ATR. The amounts of data transmitted to each subscriber unit during the frame period are summed cumulatively, to obtain a respective cumulative transmission score. At, or near, the end of the frame, each cumulative transmission score (which will generally differ somewhat from the respective data allotment, which was based on predicted ATRs) is preferably compared with the product of the respective rate factor and a sum total of all the cumulative transmission scores; the respective differences (with their signs) are noted. At the initial allotting phase of the next frame, all cumulative transmission scores are reset to zero and step 4 is preferably modified so that the data allotments of subscriber units are adjusted according to the respective differences noted at the previous frame. Thus any deviations from the respective rate factors are corrected from frame to frame and, as a result, subscriber priorities are closely adhered to.

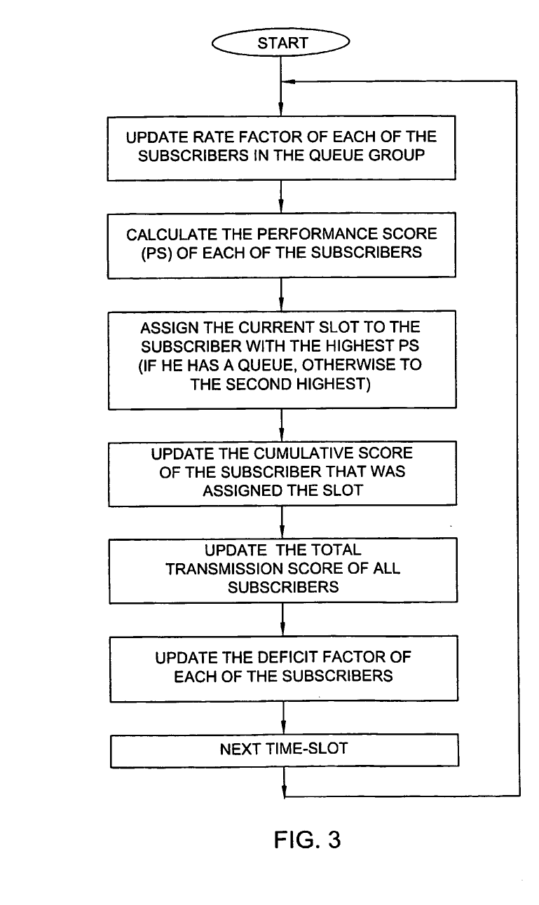

The third algorithm is illustrated by the flow diagram of FIG. 3. A Cumulative Transmission Score is kept for each subscriber unit, as the sum of all data amounts transmitted to it from the start of what is defined as a transmission session or connection. Allotting occurs each time that the queue group changes. At these instances, rate factors are determined for all subscriber units then in the queue group, in proportion to their respective priorities. At each slot time, a desired cumulative score is computed for each subscriber unit, in proportion to its rate factor and to the total of the transmission scores of the subscriber units in the queue group. The slot is allocated, among all subscriber units in the queue group, on the basis of comparison of the ratios between the desired cumulative scores and the cumulative transmission scores—all in certain relation to the respective ATRs.

Specifically, the following is done during the allotting phase:

1. A queue group is identified and the priorities of its N subscriber units are noted

2. A rate factor is computed for each of the N subscriber units, as the ratio of its priority to the sum of the priorities of all subscriber units of the queue group.

Allocation of each slot among the subscriber units of the queue group is carried out prior to its beginning as follows:

3. A total transmission score is computed as the sum of the cumulative transmission scores of all subscriber units of the queue group.

4. A Desired Cumulative Score is computed for each subscriber unit as the product of its rate factor and the total transmission score.

5. A Deficit Factor (DF) is computed for each subscriber unit as the ratio of its Desired Cumulative Score to its Cumulative Transmission Score.

6. A Preference Score (PS) is computed for each subscriber unit, as a direct function of its Deficit Factor and its current ATR, whereby these two variables are assigned given relative weights; an example of such a function is −PS=a*ATR+b*DF, where a and b are the given weight values.

7. All the Preference Scores are compared with each other and the subscriber unit with the highest Preference Score is assigned the current slot.

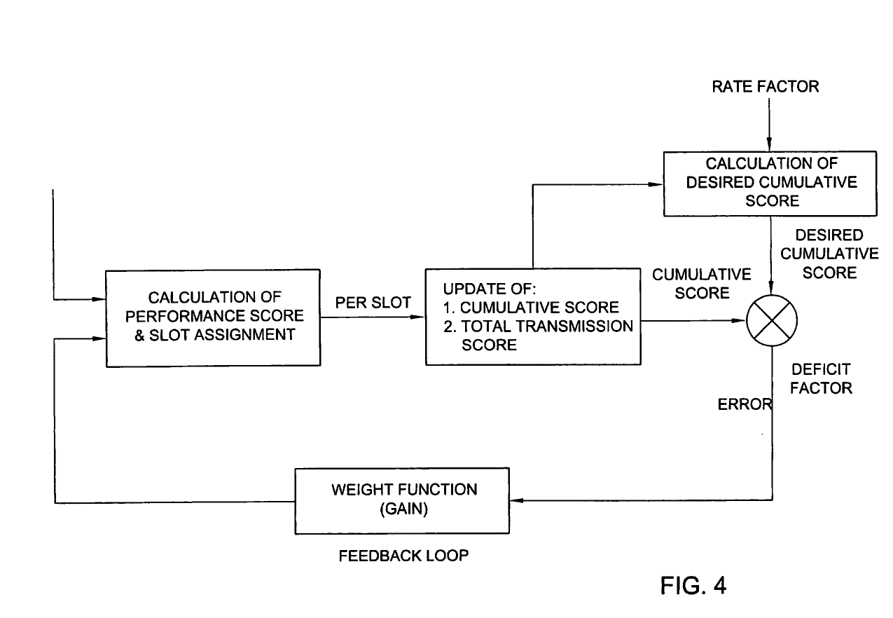

As shown schematically in FIG. 4, this process forms, in effect, a feedback control loop, in which the slot allocation scheme acts to gradually bring any Deficit Factor (which may generally be more or less than 1) to unity. The rate at which this correction occurs, and the magnitude of any remaining deficit, is determined by the relative weights in the computation of the Preference Score. On the other hand, the relative weights determine in an opposite sense the effect of the current ATR on slot allocation and therefore they determine the overall data throughput. The algorithm thus advantageously provides an adjustable balance between equitable slot allocation and overall transmission efficiency.

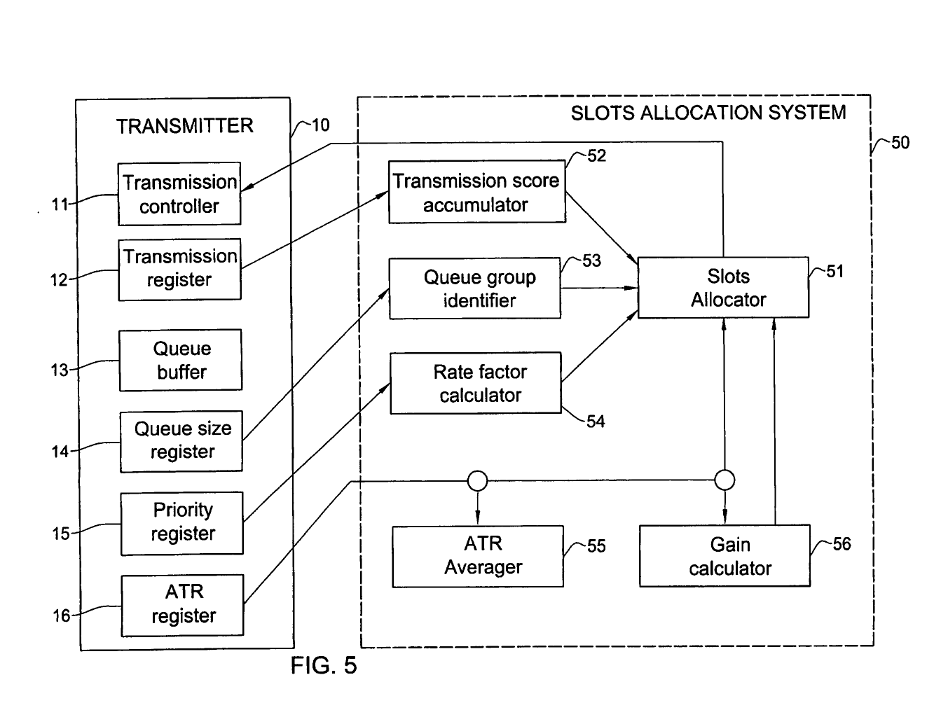

FIG. 5 shows a block diagram of a preferred slot allocation system 50 to carry out any of the methods described above. The major components (blocks) of the system are drawn within a dashed line rectangle and they communicate with certain assumed blocks in the transmitter or base station 10. These assumed blocks are not part of the invention and need not be defined as such; they only represent the availability of the corresponding parameters, variables or functions within the base station. Any of the blocks of system 50, to be explained below, may be implemented as software or hardware or as a hybrid of the two.

At the heart of the system is a slots allocator 51, whose function is to determine for each time slot the subscriber unit to which data will be transmitted over that slot. This determination may be conveyed to a controller 11 within the transmitter, causing the transmitter to transmit to the determined subscriber unit a quantity of data commensurate with its current ATR, the data being taken out from the respective queue in a queue buffer 13. The amount of data transmitted is entered for the respective subscriber unit in a transmission register 12. At the same time the respective value in a queue size register 14, which stores the sizes of corresponding queues in queue buffer 13, is reduced by that amount.

Slots allocator 51 operates on input variables supplied to it according to any of the methods described above. One group of input variables is cumulative transmission scores for the various subscriber units in the queue group, which are calculated in a transmission scores accumulator 52, which in turn continuously receives actual transmission amounts from the transmitter, e.g. from transmission register 12. Another group of input variables is the identity of subscriber units that currently have non-zero queues in the transmitter and the corresponding sizes of the queues; these identities and sizes are determined by a queue group identifier 53, which receives corresponding information from the transmitter. e.g. from queue size register 14. Another group of variables input to slots allocator 51 is the rate factors of subscriber units; these are determined by a rate factors calculator 54, which in turn operates on subscriber unit priority values, received from the transmitter—e.g. from a priorities register 15, and on identities and queue sizes of the subscriber units in a current queue group, received from queue group identifier 53. Finally, slots allocator 51 receives as input also ATR values of subscriber units, obtained from the transmitter, e.g. from an ATR register 16.

In some configurations of the invention, employing certain of the methods described above, slots allocator 51 operates also on gain values (possibly instead of ATR values), these being input to it from a gain calculator 56. Gain calculator 56 calculates gain values of subscriber units at any time slot by dividing respective ATR values by corresponding average ATR values. The latter are obtained from an ATR averager 55, which averages, for any subscriber unit, a plurality of consecutive ATR values, obtained e.g. from ATR register 16. In a certain configuration of the invention, employing a method based on predicted ATR values, as described above, the ATR values input to ATR averager 55, gain calculator 56 and slots allocator 51 are obtained from an optional predictor (not shown), which is not part of the invention and which usually operates on sequences of previous ATR values obtained e.g. from ATR register 16.

1. In a data transmission system for transmitting data from a transmitter to a plurality of receivers over a common channel in successive time slots, each time slot being allocatable to one particular receiver for transmitting data thereto, there being, for each receiver during each time slot, a given acceptable transmission rate (ATR), derived from a corresponding measured signal-to-noise ratio (SNR), and there being at any instant a quantity of data queued at the transmitter for transmission to each of a group of receivers, this group being termed a queue group, a method for adaptively allocating time slots to receivers, comprising the steps of:
(i) identifying all receivers belonging to the queue group;
(ii) determining for each receiver of the queue group a rate factor;
(iii) allocating any time slot to any receiver of the queue group, based on ATRs, and said rate factors, if any, of a plurality of receivers in the queue group;
(iv) cumulatively adding amounts of data sent to any receiver, to obtain a respective cumulative transmission score.

2. The method of claim 1 wherein, in step (iii), said allocating of any time slot is based on the ATRs of a plurality of receivers in the queue group for that time slot.

3. The method of claim 2 further including the following steps, all carried out with respect to any time slot being allocated:
(v) calculating a total transmission score as the sum of said cumulative transmission scores of all receivers of the queue group;
(vi) multiplying said total cumulative score by said rate factor of each receiver of the queue group, to obtain a corresponding desired cumulative score, and calculating, for each receiver of the queue group, the ratio of said desired cumulative score to said cumulative transmission score, to obtain a deficit factor;
(vii) for each receiver of the queue group, combining the respective one of said deficit factors with the respective ATR for said slot being allocated, according to given relative weights, to obtain a respective preference score;
and wherein, in step (iii), said allocating includes assigning the slot to the receiver with the highest preference score.

4. The method of claim 2 further including the step of calculating, for any receiver and for any slot, an average ATR over a given number of preceding slots and wherein in step (iii) said allocating is further based on the respective average ATR.

5. The method of claim 4 further including the step of calculating, for any receiver and for any time slot, the ratio of the respective ATR to the corresponding average ATR, to obtain a respective gain factor, and wherein said allocating of any time slot is based on the gain factors of a plurality of receivers for that slot.

6. The method of claim 5 wherein, in step (iii), said allocating of any time slot includes assigning the slot to the receiver with the highest gain factor.

7. The method of claim 6 further including the step of resetting all of said cumulative transmission scores to zero, considering a given quantity of data and dividing the quantity into data allotments, each data allotment corresponding to a receiver of the queue group and the allotments being proportional to the respective rate factors of the receivers; and wherein said allocating any time slot to any receiver is conditional on the respective data allotment exceeding the respective cumulative score.

8. The method of claim 1 further including the step of calculating, for any receiver, an average ATR over a given number of consecutive slots and wherein, in step (iii), said allocating of any time slot is based on the average ATRs of a plurality of receivers of the queue group.

9. The method of claim 8 further including the step of calculating, for any receiver and for any time slot, the ratio of the respective ATR to the corresponding average ATR, to obtain a respective gain factor, and wherein said allocating of any time slot is based on gain factors of a plurality of receivers.

10. The method of claim 9 there being available at any instant predicted values of ATRs for all receivers of the queue group for a given number of succeeding time slots, wherein said average ATR for any receiver is calculated from the respective predicted values over a number of succeeding time slots and wherein said gain factor is calculated for any of said succeeding time slots and for any receiver as the ratio of the respective predicted value to a corresponding average ATR.

11. The method of claim 10 further comprising the step of considering a given number of succeeding time slots, for all of which there are predicted values available for all receivers of the queue group, and wherein said allocating is done for all of said considered slots at once.

12. The method of claim 11 wherein said allocating is such that the total amount of data that would be transmitted to each receiver of the queue group over all of its allocated slots at the respective predicted ATRs is essentially proportional to its rate factor.

13. The method of claim 11 wherein said allocating includes the steps of:
(viii) dividing said considered number of slots into slot allotments, each slot allotment corresponding to a receiver of the queue group, so that the product of each slot allotment and the respective average ATR, it being a respective data allotment, is proportional to the respective rate factor;
(ix) from among all the considered slots, selecting those slots for which the gain factor of a first receiver is the highest;
(x) from among the slots selected in step (ix), selecting a smallest group of slots, if any, over which the entire data allotment of said first receiver may be transmitted at the respective predicted ATRs and assigning these slots to said first receiver;
(xi) repeating steps (ix) and (x) recursively for the remaining receivers.

14. The method of claim 13 wherein in step (x), if there is more than one of said smallest group, said selecting includes selecting from among said smallest groups the one over whose slots the least total amount of data would be transmitted at respective predicted ATRs if each of its slots were assigned to a receiver with a second highest respective gain factor.

15. The method of claim 13 wherein said allocating further includes repeating steps (ix) through (xi) for all, if any, receivers of the queue group that have not yet been assigned any slot.

16. The method of claim 13 wherein said allocating further includes the step of allocating any unassigned slots to remaining receivers of the queue group that have not been assigned any slot in a previous step, whereby any slot is assigned to that of said remaining receivers whose gain for that slot is the highest.

17. The method of claim 16 wherein said assigning of a slot to any receiver is conditional on the total amount of data transmittable to that receiver over previously assigned slots at respective predicted ATRs being less than the data allotment of that receiver.

18. The method of claim 13 wherein, if after any iteration of step (xi) all of said data allotments are transmittable over the assigned slots at the respective predicted ATRs and not all of the considered slots have been assigned, said allocating further includes repeating steps (viii) through (xi), whereby only all of the unassigned slots are considered.

19. The method of claim 13 wherein said step of considering is repeated one or more times, each for an additional number of succeeding time slots, and includes for any repetition, prior to said allocating, the steps of-
(xii) obtaining the most recent cumulative transmission score of each receiver of the queue group of the previous prediction frame and summing all of said obtained cumulative transmission scores, to obtain a total transmission score;
(xiii) multiplying said total transmission score by the rate factor of each of said receivers, to obtain a respective transmitted share; and
(xiv) calculating, for each of said receivers, the difference between said obtained cumulative transmission score and said transmitted share; and
(xv) modifying any data allotment resulting from step (viii) so as to compensate for said differences calculated in step (xiv).

20. The method of claim 9 wherein said allocating of any time slot in step (iii) is based on the gain factors for that time slot of a plurality of receivers.

21. The method of claim 20 wherein said allocating of any time slot in step (iii) includes assigning the slot to the receiver with the highest gain factor.

22. The method of claim 21 further including the step of resetting all of said cumulative transmission scores to zero, considering a given quantity of data and dividing the quantity into allotments, each allotment corresponding to a receiver of the queue group and the allotments being proportional to the respective rate factors of the receivers; and wherein said allocating any time slot to any receiver is conditional on the respective allotment exceeding the respective cumulative score.

23. The method of claim 1 wherein if in the data transmission system there is a priority value associated with each receiver, said determining in step (ii) is such that each rate factor is directly related to the ratio between the priority of the respective receiver and the priorities of all other receivers of the queue group.

24. The method of claim 1 wherein if in the data transmission system there are no priority values defined, said determining in step (ii) is such that the rate factors of all receivers of the queue group are equal.

25. A computer program comprising computer program code means for performing all the steps of claims 1 to 24 when said program is run on a computer.

26. A computer program as claimed in claim 25 embodied on a computer readable medium.

27. An adaptive slot allocation system (50), connectable to a data transmission system that transmits data from a transmitter (10) to a plurality of receivers over a common channel in successive time slots, each time slot being allocatable to one particular receiver for transmitting data thereto, there being for each receiver during each time slot, a given acceptable transmission rate (ATR), derived from a corresponding measured signal-to-noise ratio (SNR), and there being at any instant a quantity of data queued at the transmitter for transmission to each of a group of receivers, this group being termed a queue group, the adaptive slot allocation system (50) comprising:
a queue group identifier (53), operative to identify all receivers belonging to the queue group;
a rate factors calculator (54), operative to determine for each receiver of the queue group a rate factor;
a slots allocator (51), receptive to outputs of said queue group identifier and said rate factors calculator and operative to allocate any time slot to any receiver of the queue group, based on ATRs and said rate factors of a plurality of receivers in the queue group; and
a transmission scores accumulator (52), operative to cumulatively add amounts of data sent to any receiver.

28. The system of claim 27, further comprising
an ATR averager (55), operative to calculate, for any receiver and for any slot, an average ATR over a given number of preceding slots; and
a gain calculator (56), receptive to the output of said ATR averager and operative to calculate, for any receiver and for any slot, the ratio of the respective ATR to the corresponding average ATR, to obtain a respective gain factor;
and wherein said slots allocator (51) is further receptive to the output from said gain calculator and operative to allocate any time slot to any receiver of the queue group, based on the gain factors of a plurality of receivers for that slot.
